(19) United States
(12) Patent Application Publication
(10) Pub. No.: US 2015/0234373 A1
(43) Pub. Date: Aug. 20, 2015

(54) PROPORTIONAL JOG CONTROLS

(71) Applicant: LINCOLN GLOBAL, INC., City of Industry, CA (US)

(72) Inventor: Thomas R. Myers, Summerville, SC (US)

(73) Assignee: LINCOLN GLOBAL, INC., City of Industry, CA (US)

(21) Appl. No.: 14/324,794

(22) Filed: Jul. 7, 2014

Related U.S. Application Data
(60) Provisional application No. 61/942,307, filed on Feb. 20, 2014.

(51) Int. Cl. G05B 19/19; G05B 19/409

(52) U.S. Cl. CPC G05B 19/19; G05B 19/409; G05B 2219/50048; G05B 2219/35438

(57) ABSTRACT

The invention described herein generally pertains to proportional jog controls for a controller of a machining apparatus. The jog controls generate a variable signal proportional to a degree to which the jog controls are engaged by an operator. The controller, in turn, generates a motor drive signal proportional to the variable signal from the jog controls. Accordingly, the operator can jog the machining apparatus at a variable feed rate based on the degree of engagement with the jog controls which allows fine jogging control near a terminus of a jog operation.

### CROSS-REFERENCE TO RELATED APPLICATIONS AND INCORPORATION BY REFERENCE

This U.S. patent application claims the benefit of U.S. Provisional Patent Application No. 61/942,307, filed on Feb. 20, 2014. The entirety of the above-mentioned application is herein incorporated by reference.

### TECHNICAL FIELD

In general, the present invention relates to a system that controls motion of a tool. More particularly, the present invention relates to proportional jog controls for the tool.

### BACKGROUND OF THE INVENTION

Automation of a machine tool can be achieved with computer numerical control (CNC), which involves a controller executing a part program to operate the machine tool. The degree of automation can be extensive. For instance, the part program can be generated based on a computer-aided design (CAD) file and include instructions for moving the machine tool, activating the machine tool, configuring parameters of the machine tool, etc. In general, modern CNC machines enable an operator to create a workpiece easily by inputting a CAD file.

However, despite this high level of automation, manual control of the machine tool is often desired. For example, during an initial configuration stage, when a controller is first coupled to a CNC-enabled machine tool, the machine tool may be manually shifted to an origin point. Such manual control can be effected via physical manipulation of the machine tool, or via an operator panel of the controller.

In the case of manual control via the operator panel, a plurality of buttons and/or switches are provided. The plurality of buttons can include a series of jog controls to control a position and movement of the machine tool. The series of jog controls can comprise, for example, eight jog buttons arranged in the four cardinal directions as well as the four diagonal directions. Conventionally, such jog buttons operate as digital on/off switches. That is, when a jog button is depressed, the machine tool is jogged in a corresponding direction until the jog button is released.

Further, a speed at which the machine tool is jogged upon operation of the jog button corresponds to a full jogging feed rate of system (machine tool and controller). Accordingly, it can be difficult to precisely position the machine tool manually. For instance, because the machine tool may jerk at the full jog feed rate and, thus, inadvertently overshoot a target position, a series of back-and-forth operations with the jog button can be required.

### SUMMARY OF THE INVENTION

In accordance with an embodiment of the present invention, a controller for a machining apparatus is provided. The controller can include a jogging control operable by an operator to alter a position of a tool of the machining apparatus. The jogging control is configured, upon engagement by the operator, to generate a jogging input signal having a variable magnitude. The jogging input signal can be dependent on a position, of the plurality of positions, to which the jogging control is engaged. The controller can further include a motion controller configured to output a variable motor drive signal to a motor of the machining apparatus in response to the jogging input signal, wherein the variable motor drive signal is proportional to the jogging input signal.

In accordance with another embodiment of the present invention, a method is described. The method includes receiving an input signal from a jogging control, the input signal having a variable magnitude based upon a degree of activation of the jogging control by an operator. In addition, the method can include generating a jogging output signal that is proportional to the input signal. Further, the method includes outputting a motor drive signal to a motor of the machining apparatus in accordance with jogging output signal.

In yet another embodiment of the present invention, a system is provided. The system includes a machining apparatus for performing a machining operation on a workpiece. The machining apparatus includes an implement that performs the machining operation and one or more motors coupled to the implement. The one or more motors are controllable to change a position of the implement relative to the workpiece. The system further includes a controller having a motion controller, a control application, and an operator panel. The operator panel provides a set of jogging controls respectively corresponding to forward or reverse directions of the one or more motors. The set of jogging controls are respectively configured to output variable signals corresponding to respective degrees of engagement by an operator. The variable signals from the set of jogging controls are processed by the control application to generate jogging output signals which are proportional thereto. The motion controller generates motor drive signals based on the jogging output signals. The motor drive signals drive the one or more motors in the forward or reverse directions at a speed proportional to the degrees of engagement of the set of jogging controls.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a machining system for controlling a position of a tool of a machining apparatus;

FIG. 2 illustrates an exemplary, non-limiting operator panel for a controller;

FIG. 3 illustrates a jog operation with digital jog controls;

FIG. 4 illustrates a jog operation performed with proportional jog controls;

FIG. 5 illustrates an exemplary, non-limiting control application executing on the machining system of FIG. 1;

FIG. 6 is a flow diagram of outputting a motor drive signal proportionally with an input signal;

FIG. 7 illustrates a perspective view of a cutting system;

FIG. 8 illustrates a perspective view of a computer numeric control cutting system;

FIG. 9 illustrates a perspective view of a computer numeric control cutting system; and

FIG. 10 illustrates a cutting system.

### DETAILED DESCRIPTION OF THE INVENTION

Embodiments of the invention relate to systems and methods for jog operations performed on a machining apparatus. As utilized herein, a “machining apparatus” is a device or system for performing a machining operation. A machining operation can include various actions performed on a workpiece such as, but not limited to, cutting, marking, routing, grinding, milling, lathing, sawing, drilling, boring, etc. The jog operations involve a variable feed rate generated proportionally to an degree to which a jog control is engaged by an operator. Exemplary embodiments will now be described with reference to the drawings. The examples and drawings are illustrative only and not meant to limit the invention, which is measured by the scope and spirit of the claims. Like reference numerals refer to like elements throughout.

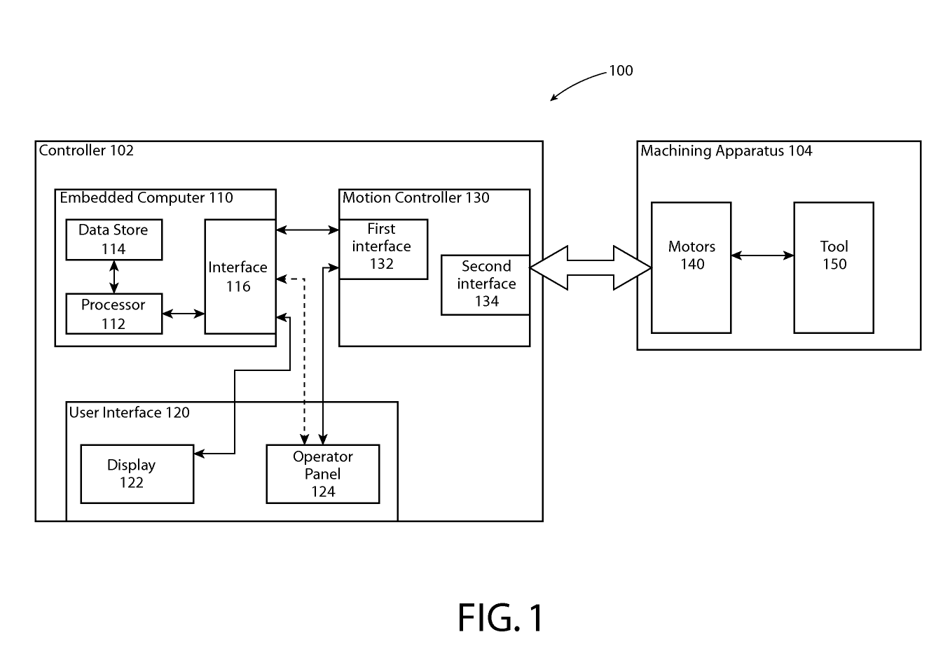

FIG. 1 illustrates one example of a CNC machining system 100 capable of performing a machining operation. As shown in FIG. 1, system 100 includes a controller 102 communicatively coupled to a machining apparatus 104. The controller 102 executes a control application and transmits signals to the machining apparatus 104 to perform the machining operation. The control application enables configuration of the machining apparatus 104 or machining operation, manual control of the machining apparatus 104 and/or machining operation, parameter setting, executing of machining operations, and the like. In addition, the control application can run a part program to control the machining apparatus 104 to perform the machining operation for a specific workpiece. As mentioned previously, the part program can be generated from a CAD file or other design file, created by a numerical control programmer, or both (e.g., generated from the CAD file and refined by the programmer). In other example, the part program can be pre-loaded program or subroutine included in the control application on controller 102.

Controller 102 can include an embedded computer 110 having a processor 112, a data store 114, and an interface 116. The processor 112 is configured to execute computer-executable instructions, including at least the part program for causing the machining apparatus 104 to perform the machining operation. The processor 112 can also execute computer-executable instructions for an operating system; the control application for loading the part program, starting/stopping the part program, configuring the machining apparatus 104 or parameters of the part program, generating the part program, manually effecting operations on the machining apparatus 104, or the like; or any other program or application. The computer-executable instructions for the control application, the operating system, the part program, etc., can be retained on a non-transitory, computer-readable medium such as data store 114. According to an embodiment, data store 114 can include volatile storage (e.g., a random access memory, a data cache, a register) and/or non-volatile storage such as a hard drive, flash memory, removable media (e.g., floppy disk, USB drive, optical disc, etc.), a ROM, etc. For the purposes of this description, the various forms of computer-readable media described above are collectively shown and referred to as data store 114.

The embedded computer 110 further includes an interface 116 to couple processor 112 and data store 114, and subsequently the programs and applications executing thereon, to other components of the controller 102. Interface 116 can include various wired or wireless interfaces or connection points. For instance, interface 116 can include video ports, serial ports, parallel ports, USB ports, or other communication ports. Interface 116 can also include a wireless interface to enable communications via a wireless protocol such as WiFi or other wireless LAN protocol; Bluetooth, Wireless USB, or other similar RF protocol; a cellular radio protocol; an infrared protocol; or the like.

According to another aspect, controller 102 can include a user interface 120. The user interface 120 can comprise a display 122, which can be a touch display capable of supplying visual output and receiving user input, and an operator panel 124. Operator panel 124 can includes various physical switches, buttons, knobs, dials, and the like, which are operable by a user to control various functions of the controller 102. As indicated in FIG. 1, display 122 provides input and output functionality to the embedded computer 110 (and the applications, programs, and operating systems executing thereon). Moreover, operator panel 124 offers direct, manual control of machining apparatus 104 without dependence on the embedded computer 110 as shown in FIG. 1. However, it is to be appreciated that the operator panel 124 and the embedded computer 110 can interoperate in a variety of ways. For example, input received via the operator panel 124 can be transmitted to the machining apparatus 104 by way of the embedded computer 110 (i.e., via software executing thereon). Such a routing scheme enables the embedded computer 110 (i.e., the software running thereon) to influence the input received via the operator panel 124. For instance, the controller application executing on the embedded computer 110 can impose safety constraints or otherwise sanitize input received via the operator panel 124 to prevent unsafe conditions. This routing scheme also enables the operator panel 124 to leverage features of the controller application to facilitate enhanced manual control of the machining apparatus 104. According to another example, the input received via the operator panel 124 can be forwarded to the embedded computer 110 while also being processed for transmission to the machining apparatus 104. In this manner, the embedded computer 110, and particularly software executing on the embedded computer, can maintain a current status of the machining apparatus 104.

As further shown in FIG. 1, the controller 102 include a motion controller 130 configured to output signals to motors 140 of machining apparatus 104 to effect changes in a position of tool 150. The motion controller 130 can receive input at a first interface 132, convert the input into appropriate analog signals to drive motors 140, and output the analog signals to the motors 140 via a second interface 134. As with interface 116 of embedded computer 110, first interface 132 and second interface 134 can be facilitate a wired and/or wireless connection with communication partners. As shown in FIG. 1, the input received at first interface 132 can originate from the embedded computer 110 and/or the operator panel 124. Motors 140 can be respectively associated with one or more dimensions or axes of the machining apparatus 104. Typically, the axes are defined relative to the machining apparatus 104. For example, for at machining tool operating on a table surface, x and y axes can be defined by the surface (i.e., lie in the surface) with a z-axis orthogonal to the surface. In some machining apparatuses, a z-axis position refers to a height of the tool 150 above the table surface or workpiece. In other machining apparatuses, additional axes can be associated with motors. For example, CNC lathes can have an A-axis corresponding to an axis of rotation of the workpiece.

While FIG. 1 only depicts motion controller 130 interfacing with machining apparatus 104, it is to be appreciated that the controller 102 can include additional interfaces, circuits, integrated controllers, or the like to facilitate control of other aspects of the machining apparatus 104 beyond positioning of the tool 150. For instance, controller 102 can include components to control an activation state of tool 150, a power source to tool 150 and/or machining apparatus 104, consumable feed rates for tool 150, or substantially any other aspect of machining apparatus 104 manageable in the performance of the machining operation.

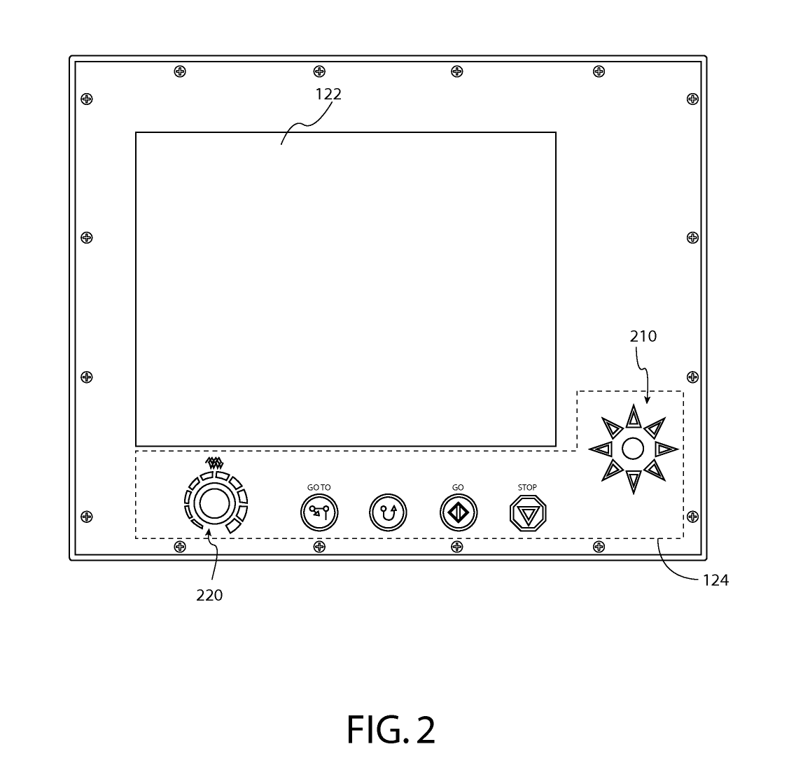

As mentioned previously, operator panel 124 enables an operator to execute manual control operations on machining apparatus 104. For example, the operator can jog the tool 150 to a desired or target position, change a height of tool 150, or the like. Turning to FIG. 2, an exemplary, non-limiting embodiment of a front panel of controller 102 is illustrated. As shown in FIG. 2, the front panel exposes the display 122 and the operator panel 124. The operator panel 124 includes various buttons and knobs including jog controls 210 and a jog feed rate potentiometer 220. The jog controls 210 enable the operator to jog the tool 150 along two axes, which are typically labeled the x and y axes. For example, the up arrow of jog controls 210 can move the tool 150 in a positive y direction, the right arrow corresponds to a positive x direction, the down arrow to a negative y direction, and the left arrow to the negative x direction. The diagonal buttons of jog controls 210 provide simultaneous operation of two motors 140 respectively associated with the x and y axes. The northeast button provides movement in a positive x and positive y direction, the southeast button provides movement in the positive x and negative y direction, the southwest button provide movement in the negative x and negative y direction, and the northwest button provides movement in the negative x and positive y direction. The jog feed rate potentiometer 220 enables the operator to adjust the jogging feed rate of the system as a percentage of a system default (i.e., the full jogging feed rate). That is, through operation of the potentiometer 220, the speed at which the tool 150 is jogged by operation of jog controls 210 becomes some percentage of the full jogging feed rate depending on the position of the potentiometer 220. While FIG. 2 depicts jog controls 210 as buttons (i.e., push buttons, membrane switches, etc.), it is to be appreciated that other types of controls can be utilized for jog controls 210. For instance, other controls can include, but are not limited to, analog or digital joysticks, touch-sensitive input pads, roller ball input devices, or the like. In general, substantially any type of input device can be utilized as jog controls 210 so long as the type of control provided by the input device is capable of reporting a variable signal corresponding to a degree of activation between, inclusively, an off state and a fully on state position.

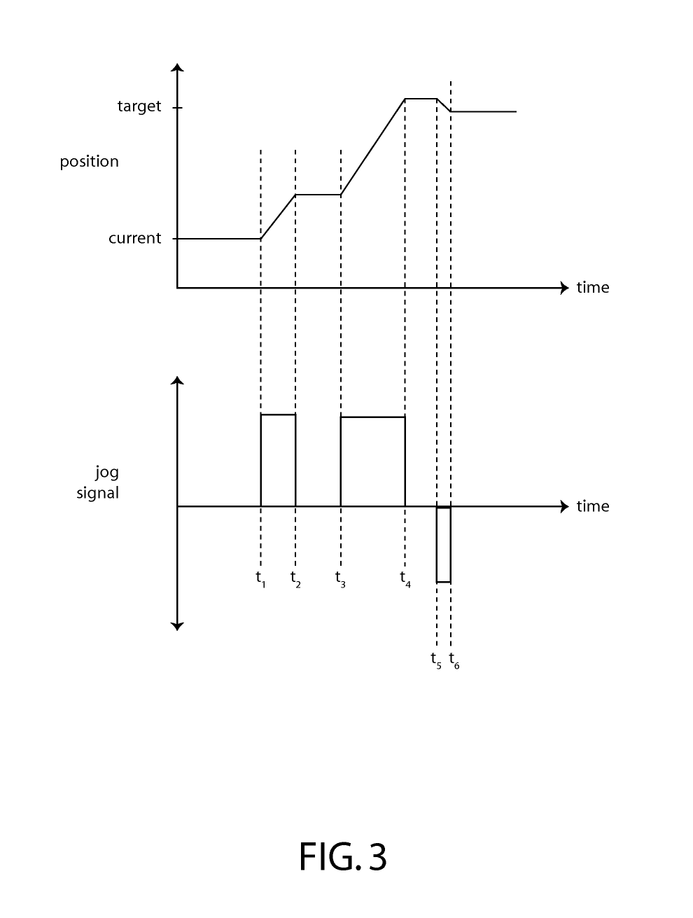

As described above, jog controls, like those depicted as jog controls 210, are conventionally digital buttons. That is, the jog controls merely output a digital on/off signal depending on whether the button is depressed or not. In other words, a degree of depression is neither measured nor output. Accordingly, upon activation of a jog control button, the tool 150 lurches at a full jogging feed rate. This can result in scenarios illustrated in FIG. 3, for example. As shown in FIG. 3, a jog operation from a current position to a target position is performed. For instance, the current position can be a specific current x-coordinate and the target position corresponds to a target x-coordinate such that the jog operation involves movement along the x-axis of machining apparatus 104. Accordingly, the operator utilizes the left and/or right arrows of jog controls 210. With conventional controls, a jog signal is produced as a pulse corresponding to the full jog feed rate of the system, which in turn effectuates a change in the position. At time t1, the right jog control is depressed and held until time t2 to cause a change in position as shown. At time t3, the right jog control is depressed again to change the position. However, upon release of the jog control at time t4, the target position has been overshot. Accordingly, the left jog control is activated from time t5 to time t6 to move the tool 150 to the target position.

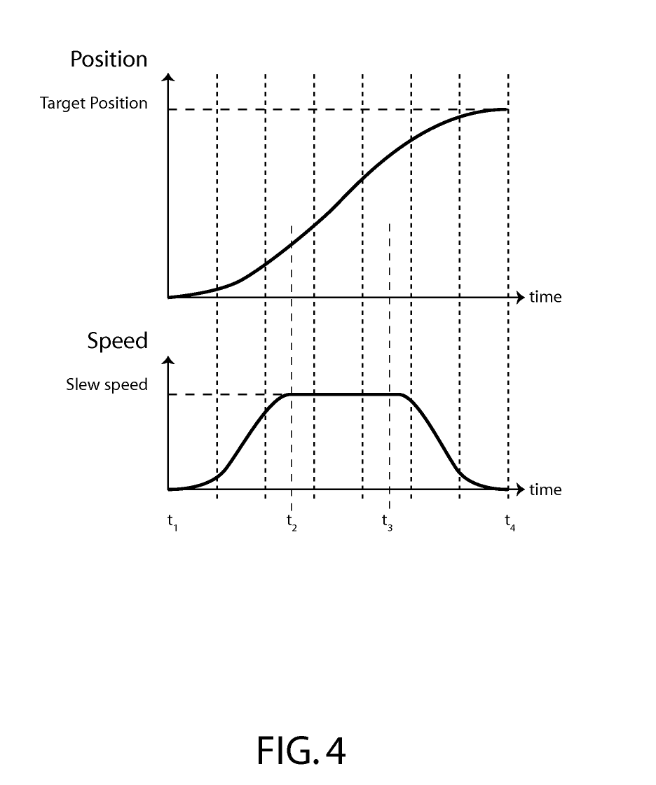

In accordance with an aspect, jog controls 210 can be proportional controls that enable a variable jog speed in proportion to a degree of activation of the controls. For instance, jog controls 210 can be pressure-sensitive buttons that respectively output a signal that indicates a pressure exerted on the button. The signal output can be variable between no signal corresponding to an off or unengaged position and a maximum signal corresponding to a maximally on or fully engaged position. Based upon a position to which the button is engaged between the off position and the fully engaged position, a corresponding signal between no signal and the maximum signal is output. Turning to FIG. 4, a jog operation performed with proportional controls is illustrated. At time t1, a jog control is activated with increasing pressure until time t2 where a constant pressure on the jog control is maintained. This action results in an acceleration of the tool 150 from a stationary state to a slew speed and initiates movement of the tool 150 from a current position towards a target position. As shown in FIG. 4, the pressure associated with the slew speed is maintained until time t3. At time t3, the pressure exerted on the jog control is reduced until time t4 when the jog control is released. In response, the tool 150 is decelerated from the slew speed to the stationary state between time t3 and time t4 to arrive at the target position.

The variable output signal of the jog controls 210 can be processed by motion controller 130 to modulate (i.e., attenuate or amplify) the motor output signal transmitted to motors 140. For instance, the motor output signal can vary from no output to a maximum output corresponding to the full jogging feed rate of the system depending on the output signals from the jog controls 210. In other words, according to one aspect, an output signal generated by a user operating the jog controls 210 can be directly routed to motors 140 via motion controller 130 of the controller 102. According to another example, the variable output signal of the jog controls 210 can be provided to the embedded computer 110. In this example, an internal parameter, such as a feed rate parameter of the software, can be manipulated to effectuate a variable jogging speed dependent on the magnitude to which the jog controls 210 are engaged.

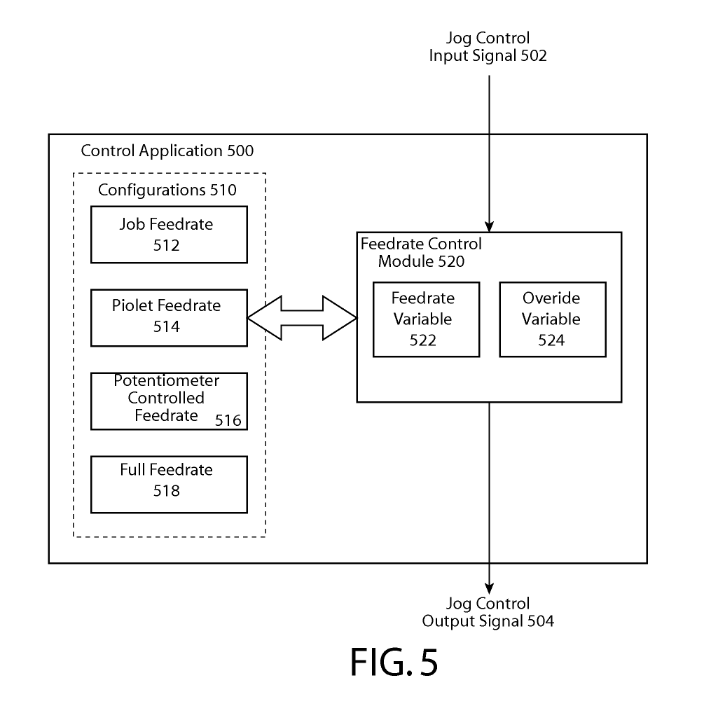

Turning to FIG. 5, an exemplary, non-limiting embodiment of providing proportional jog controls is illustrated. As shown is FIG. 5, a control application 500 receives a jog control input signal 502 and outputs a jog control output signal 504. The control application 500 can comprise computer-executable instructions executed on embedded computer 110 of controller 102 from FIG. 1. Accordingly, in one example, the jog control input signal 502 can be received from jog controls 210 and the jog control output signal 504 is transmitted to motors 140 via motion controller 130.

As described above, the jog control input signal 502 is proportional to a degree of activation of jog controls 210. Moreover, the jog control output signal 504 is proportional to the jog control input signal 502, thereby making the jog control output signal 504 proportional to the degree of activation of jog controls 210. That is, a level of the jog control output signal 504 corresponds to a level of the jog control input signal 502 according to a relationship. For instance, a one-to-one relationship can be utilized such that the level of the jog control output signal 504 matches the level of the jog control input signal 502. According to another example, the respective levels of the jog control input signal 502 and jog control output signal 504 can align within respective scales. That is, given the level of the jog control input signal 502 in an input scale from a zero input signal to a maximum input signal, the level of the jog control output signal 504 can be a proportional or equivalent level within an output scale from a zero output signal to a maximum output signal. For instance, when at the level of the jog control input signal 502 is 75% of the maximum input signal, then the jog control output signal 504 is 75% of the maximum output signal. In yet other example, the jog control input signal 502 is multiplied or attenuated by a predetermined factor to generate the jog control output signal 504. The foregoing are some examples of proportional relationships between the jog control input signal 502 and the jog control output signal 504 and the claims appended hereto are not limited to the relationships described above. It is to be appreciated that other relationships are contemplated and can be employed with the claimed subject matter. Moreover, it is to be appreciated that a proportional relationship between the signal emitted from the jog controls 210 and the jog control input signal 502 can be one of the relationships described above, or some other relationship, and, accordingly, can be the same relationship that exists between the jog control input signal 502, or a different proportional relationship.

The control application 500 can implement the relationship between the jog control input signal 502 and the jog control output signal 504 in a variety of ways including direct manipulation of the signals 502, 504, via processing in software, manipulation of software parameters or variables, etc. According to an aspect, the control application 500 can include a feed rate control module 520 that receives the jog control input signal 502, processes the signal 502, and generates the jog control output signal 504. The feed rate control module 520 maintains two variables—a feed rate variable 522 and an override variable 524. The feed rate variable 522 can be established according to one configuration from configurations 510. The set of configurations 510 include a job feed rate configuration 512, a preset feed rate configuration 514, a potentiometer-controlled feed rate configuration 516, and a full feed rate configuration 518. The job feed rate configuration 512 sets the feed rate variable 522 to an embedded feed rate value from a part program. The preset feed rate configuration 514 sets the feed rate variable 522 to a user-selected value. The potentiometer-controlled feed rate configuration 516 sets the feed rate variable 522 to a system maximum but activates potentiometer 220 to enable modification of the feed rate in real time. The full feed rate configuration 518 sets the feed rate variable 522 to the system maximum but disables the potentiometer 220.

With conventional, non-proportional digital jog controls, the tool 150 is jogged according to the set feed rate variable 522 whenever one of jog controls 210 is actuated. In other words, with conventional systems, the jog control output signal 504 is generated based on a value of feed rate variable 522, without consideration of a value or level of the jog control input signal 502. When the feed rate variable 522 is established according to the potentiometer-controlled feed rate configuration 516, it is to be appreciated that the jog control output signal 504 can also be influenced by the potentiometer 520 in addition to the value of the feed rate variable 522.

However, in accordance with an aspect, the jog control output signal 504 is generated with respect to a level or value of the jog control input signal 502 which, in turn, is determined based on an amount of pressure applied to or a degree of activation of jog controls 210. As shown in FIG. 5, the feed rate control module 520 utilizes the override variable 524 to generate a proportional output. For instance, in one example, the feed rate variable 522 establishes a baseline value or a maximum value for the jog control output signal 504. Based on the jog control input signal 502, the feed rate control module 520 scales the value rate variable 522, proportionally, to establish a value for the override variable 524. From the value of the override variable 524, the jog control output signal 504 is generated. Thus, the variable jog control output provided proportionally to a pressure, analog, or other variable input from jog controls 210 does not disrupt a configured jogging feed rate of the system.

According to another example, the override variable 524 can be utilized to enable the potentiometer-controlled feed rate configuration 516. In such example, the feed rate variable 522 is set to a system maximum and the override variable 524 holds a scaled value of the system maximum according to a setting of the potentiometer 220. In conventional systems, the feed rate control module 520 generates the jog control output signal 504 based on the scaled value maintained by the override variable 524. Alternatively, the override variable 524 can hold the setting of the potentiometer 220 as opposed to the scaled value. In this alternative, the feed rate control module 520 scales the value of the feed rate variable 522 according to the value of the override variable 524 to generate the jog control output signal 504. In an aspect, the feed rate control module 520 can temporarily utilize the override variable 524 to proportionally scale the feed rate variable 522 based on the jog control input signal 502. After processing the jog control input signal 502 and generating the jog control output signal 504, the feed rate control module 520 can restore the override variable 524 to a previous value (i.e., the value prior to the processing of the jog control input signal 502). For instance, the feed rate control module 520 can create a shadow copy of the override variable 524, utilize the override variable 524 to generate the jog control output signal 504, and subsequently restore the override variable with the shadow copy.

The foregoing description of control application 500 illustrates one exemplary, non-limiting embodiment of a system for providing proportional jog controls. It is to be appreciated that other mechanisms can be employed to generate jogging control signals which are coordinated or proportional to an amount of pressure applied to or a degree of activation of jog controls of a user interface. The claimed subject matter, unless explicitly stated otherwise, is intended to cover these alternatives. Moreover, while the above embodiment are described relative to jog controls, it is to be appreciated that the aspects described herein can also be applied to height control of a tool.

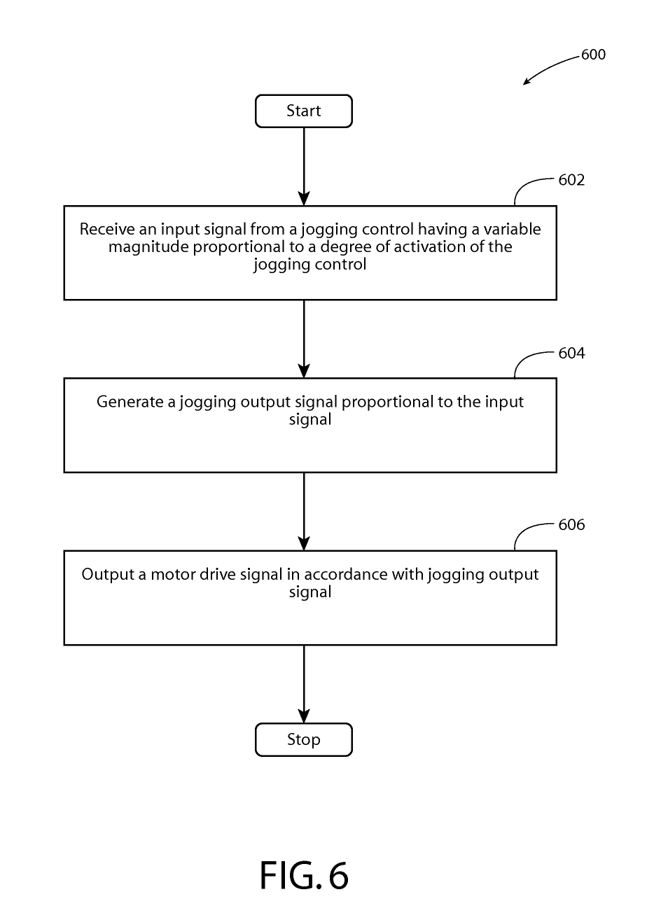

In view of the exemplary devices and elements described supra, a methodology that may be implemented in accordance with the disclosed subject matter will be better appreciated with reference to a flow chart and/or methodology of FIG. 6. The methodology and/or flow diagram is shown and described as a series of blocks. The claimed subject matter is not limited by the order of the blocks, as some blocks may occur in different orders and/or concurrently with other blocks from what is depicted and described herein. Moreover, not all illustrated blocks may be required to implement the method and/or flow diagram described hereinafter.

FIG. 6 illustrates a method 600 for jogging a machining apparatus. At 602, an input signal is received from a jogging control. According to an aspect, the input signal has a variable magnitude which depends upon a degree of activation, by an operator for example, of the jogging control. At 604, a jogging output signal is generated. The jogging output signal is proportional to the input signal. In an example, the jogging output signal can be generated by scaling a base feed rate signal in proportion to the input signal. Scaling can involve attenuating the base feed rate signal or multiplying the base feed rate signal. The amount of multiplication or attenuation can be proportional to the degree of activation of the jogging control. For instance, the base feed rate signal can be reduced or amplified by a percentage which is determined from, and proportional to, a percentage of activation of the jogging control. At 606, a motor drive signal is output to a motor of the machining apparatus in accordance with the jogging output signal.

Described above are proportional jog controls 210 employable by an operator to effect manual control of a position of tool 150 of machining apparatus 104, a motion controller 130 that outputs motor driving signals in proportion to input signals from the proportional jog controls, and corresponding methods. According to an example, machining apparatus 104 can be a cutting apparatus used to cut or mark a workpiece that has a thickness and is composed of a type of material such as steel, metal, aluminum, among others. Generally, a cutting operation is cutting completely through the workpiece and a marking operation is marking a surface of the workpiece. Such systems can include, laser cutting systems, waterjet cutting systems, automated cutting systems, plasma cutting systems, and combinations thereof, among others.

Laser cutting systems uses a laser to cut materials. A laser cutting system directing a high-power laser at the workpiece to be cut or marked. The workpiece can be either melt, burned, vaporized away, or is blown away by a jet of gas, leaving a high-quality surface and clean edge. For instance, laser cutting systems can be used to cut or mark flat-sheet material as well as structural and piping materials.

Waterjet cutting systems use a liquid only or liquid that carries an abrasive delivered at high-pressure to machine a workpiece. The composition of the liquid or the liquid/abrasive combination may vary depending on the workpiece material or the machining operation. For example, a liquid/abrasive combination may be used, such as a garnet and water mixture, to machine materials such as metal or granite and a liquid only, such as water, may be used to machine rubber or wood.

Plasma cutting tools used to cut or otherwise operate on a workpiece typically comprise a gas nozzle with an electrode therein. Generally, plasma tools direct gas through a nozzle toward the workpiece, with some or all the gas ionized in a plasma arc between the electrode and the workpiece. The arc is used to cut, mark or otherwise machine the workpiece.

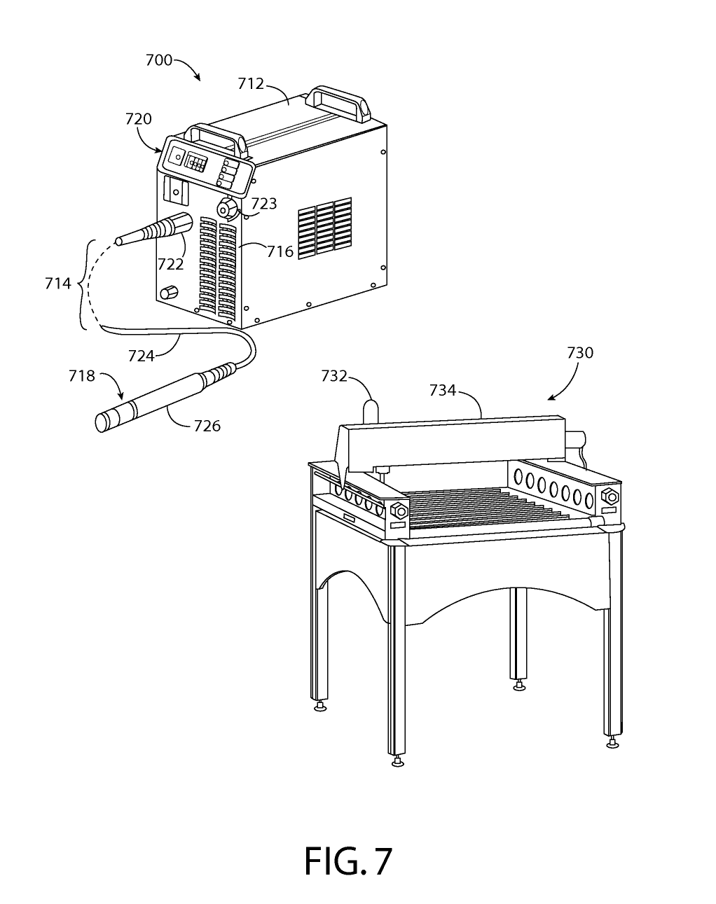

Turning to FIG. 7, illustrated is one example of a cutting system 700 that performs a plasma cutting operation. It is to be appreciated that the subject innovation can be utilized with any suitable cutting system or machining system that performs a cutting, a marking, a routing, or other machining operation and plasma cutting is solely used for example. In addition, other plasma arc torch systems of different configurations may be used with the present invention as well.

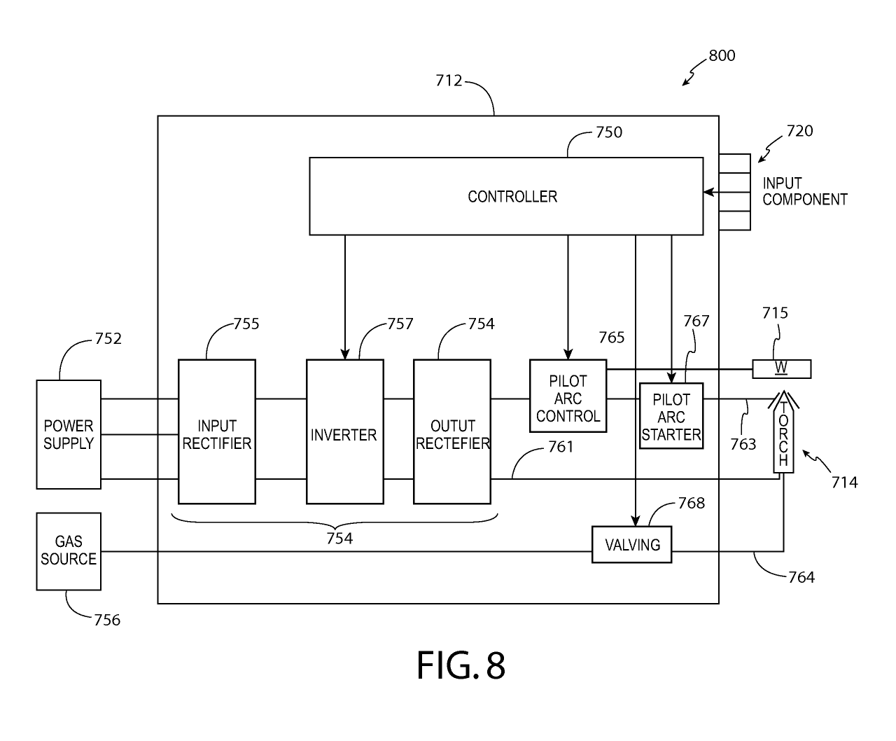

As shown, system 700 includes a control unit having a housing 712 with a connected torch 714. Housing 712 includes various components for controlling a plasma arc, such as a power supply, a plasma starting circuit, air regulators, input and output electrical and gas connectors, controllers, etc. (discussed in FIG. 8). Torch 714 is attached to a front side 716 of housing. Torch 714 includes within it electrical connectors to connect an electrode and a nozzle within the torch end 718 to electrical connectors within housing 712. Separate electrical pathways may be provided for a pilot arc and a working arc, with switching elements provided within housing 712. A gas conduit is also present within torch 714 to transfer the gas that becomes the plasma arc to the torch tip. Input component 720 can receive a user input. In an embodiment, input component 720 may be provided on housing 712 (as illustrated), along with various electrical and gas connectors. For instance, the input component can be, but is not limited to, buttons, switches, touch screen, voice command, microphone for audio input, camera for gesture control input, among others.

It should be understood that the housing 712 illustrated in FIG. 7 is but a single example that could employ aspects of the inventive the concepts disclosed herein. Accordingly, the general disclosure and description above should not be considered limiting in any way as to the types or sizes of plasma arc systems that could employ the disclosed elements. Particular components and controls will be discussed in detail below with reference to FIG. 8.

As shown in FIG. 7, torch 714 includes a connector 722 at one end for attaching to a mating connector 723 of housing 712. When connected in such way, the various electrical and gas passageways through the hose portion 724 of torch 714 are connected so as to place the relevant portions of torch body 726 in connection with the relevant portions within housing 712.

In an embodiment, the cutting system 700 can be utilized with a support 730 that facilitates automation of the cutting operation. For instance, the support 730 can be a structure on which the workpiece is placed. In a particular embodiment, support 730 can be a cutting table and gantry 734 can be used with at least torch 714. Support 730 can include components that provide motion to at least one of the torch 714 about the workpiece W or the workpiece W about the torch 714. In an embodiment, a motion controller (not shown) can be utilized to provide motion to at least one of the workpiece W or torch to perform the cutting operation to achieve the desired workpiece. For example, the motion controller can be incorporated into cutting system 700, into support 730, a stand-alone component, or a combination thereof. In an embodiment, a portion of torch 714 can be inserted into holder 732 to perform an automated or semi-automated cutting operation. For instance, controls used by the cutting system 700 and support 730 can be machine readable instructions to achieve the desired workpiece from the cutting operation. The support 730 is illustrated for example and any suitable support 730 can be chosen with sound engineering judgment without departing from the intended scope of embodiments of the subject innovation.

FIG. 8 illustrates a plasma arc cutting control system 800 that can be utilized with aspects of the subject innovation. As shown, cutting system 800 includes housing 712 and torch 714, as mentioned above. Element 715 represents workpiece W being cut or marked. A controller 750 is provided within housing 712 to control various aspects of the cutting control system 800 and/or cutting system 700. Accordingly, controller 750 could comprise a digital signal processor, microprocessor, programmable gate array control or the like, a memory, and control software. Controller 750 can direct operation of the cutting system 700. Additionally, a motion controller (not shown) can be utilized with cutting control system 800 to provide velocity and geometric coordinates to actuate torch 714 about a workpiece. Alternatively, the motion controller can be utilized with cutting control system 800 to provide velocity and geometric coordinates to actuate a workpiece about torch 714.

A power supply 752 is connected to an inverter power control circuit 754 the output of which helps provide fast response for the control of plasma current in use. As shown, circuit 754 may include an input rectifier 755, an inverter 757, and an output rectifier 759. The output 761 of circuit 754 provides a DC signal to torch 714 that can be delivered at a first level (such as 10 A) for marking and a second level (such as 100 A) for cutting. Controller 750 directs circuit 754 to provide the desired output based on input given by a user via input devices 720. For starting torch 714, controller 750 can direct a pilot arc 763 be generated via a pilot arc control 765 and a pilot arc starter 767.

A gas source 756 is provided to housing 712 with gas pressure and flow control means such as valving 758 controlled by controller 750 to provide a gas flow 769 desired for either marking or cutting. If desired, such valving could incorporate pulse width modulation.

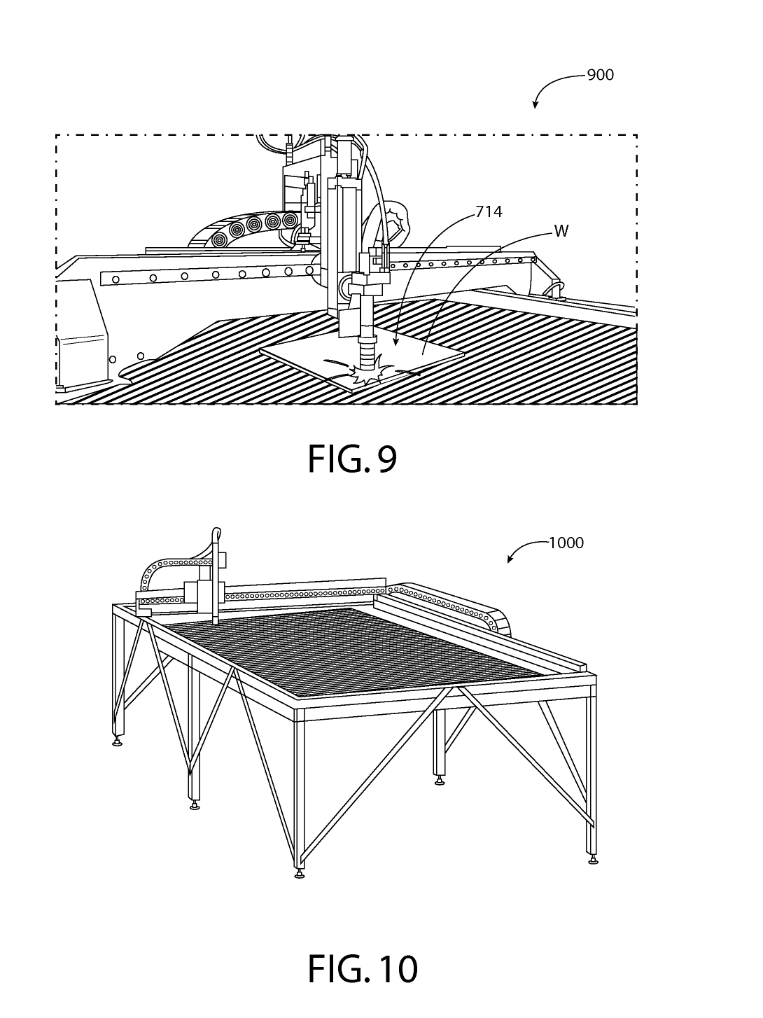

FIGS. 9 and 10 illustrate exemplary cutting systems. FIG. 9 illustrates a cutting system 900 that performs a plasma cutting operation in an automated environment. FIG. 10 illustrates a cutting system 1000 that performs a cutting operation with automation in a more portable configuration. Both cutting systems 900 and 1000 can be a computer numeric control (CNC) cutting system that provides automated control to perform a cutting operation via machine readable instructions. It is to be appreciated that cutting system 900 in FIG. 9 and cutting system 1000 in FIG. 10 are not to be limiting on the subject innovation but are solely for example.

Cutting systems 900 and 1000 perform automated cutting operations with machine readable instructions that include one or more geometric coordinates (e.g., x axis, y axis, and z axis) and a cutting velocity to use while creating a non-scrap edge on the desired workpiece.

In an embodiment, the lead component dynamically adjusts the lead in profile based on a cutting parameter detected in real time during a time before the cutting operation, wherein the cutting parameter is at least one of the cutting velocity or the thickness of the workpiece. In an embodiment, the lead component dynamically adjusts the lead out profile based on a cutting parameter detected in real time during a time after the cutting operation, wherein the cutting parameter is at least one of the cutting velocity or the thickness of the workpiece.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those skilled in the art.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A controller for a machining apparatus, comprising:
a jogging control operable by an operator to alter a position of a tool of the machining apparatus, the jogging control being configured, upon engagement by the operator, to generate a jogging input signal having a variable magnitude; and
a motion controller configured to output a variable motor drive signal to a motor of the machining apparatus in response to the jogging input signal, wherein the variable motor drive signal is proportional to the jogging input signal.

2. The controller of claim 1, wherein the jogging control is variably engageable by the operator between a non-engaged state and a fully-engaged state, inclusively.

3. The controller of claim 2, wherein the jogging control generates a zero magnitude signal as the jogging input signal when in the non-engaged state and generates a maximum magnitude signal as the jogging input signal when in the fully-engaged state.

4. The controller of claim 3, wherein, when the jogging control is engaged to an intermediate position between the non-engaged state and the fully-engaged state, the jogging control generates a signal having a magnitude at an equivalent intermediate position between the zero magnitude signal and the maximum magnitude signal.

5. The controller of claim 1, wherein the variable magnitude of the jogging input signal is based on a level of engagement of the jogging control by the operator.

6. The controller of claim 5, wherein the variable magnitude of the jogging input signal is proportional to the level of engagement of the jogging control.

7. The controller of claim 1, wherein the jogging control is a pressure-sensitive button, the jogging input signal varies in accordance with a pressure exerted.

8. The controller of claim 1, further comprising a height control operable to alter a height of the tool of the machining apparatus relative to a workpiece, and configured to generate a height control input signal having a variable magnitude,
wherein the motion controller is further configured to generate a height control output signal that is proportional to the height control input signal.

9. The controller of claim 8, wherein the height control is variably engageable by the operator between a non-engaged state and a fully-engaged state inclusively, and
the variable magnitude of the height control input signal is based on a level of engagement of the height control by the operator.

10. The controller of claim 1, further comprising a computer processor coupled to a non-transitory, computer-readable medium having stored thereon instructions for a control application executable by the computer processor,
wherein the control application receives the jogging input signal, generates a jogging output signal based on the jogging input signal, and transmits the jogging output signal to the motion controller.

11. The controller of claim 10, wherein the control application maintains a feed rate variable storing a configured feed rate, the control application generates the jogging output signal based on the configured feed rate and the jogging input signal.

12. The controller of claim 11, wherein the control application temporarily overwrites the value of the feed rate variable with a new value determined based on the jogging input signal.

13. The controller of claim 12, wherein the control application restores the value of the feed rate variable to the configured feed rate after generation of the jogging output signal.

14. The controller of claim 1, wherein the motion controller scales a default motor drive signal based on the jogging input signal.

15. The controller of claim 1, wherein the jogging control is a joystick.

16. A method for jogging a tool of a machining apparatus, comprising:
receiving an input signal from a jogging control, the input signal having a variable magnitude based on a degree of activation of the jogging control by an operator;
generating a jogging output signal that is proportional to the input signal; and
outputting a motor drive signal to a motor of the machining apparatus in accordance with jogging output signal.

17. The method of claim 16, wherein generating the jogging output signal comprises scaling a base feed rate signal in proportion to the input signal.

18. The method of claim 17, wherein scaling the base feed rate signal comprises attenuating the base feed rate signal in accordance with the input signal.

19. The method of claim 18, wherein an amount of reduction to the base feed rate signal is proportional to the degree of activation of the jogging control.

20. The method of claim 17, wherein scaling the base feed rate signal comprises multiplying the base feed rate signal in accordance with the input signal.

21. The method of claim 20, wherein an amount of amplification to the base feed rate signal is proportional to the degree of activation of the jogging control.

22. A system, comprising:
a machining apparatus for performing a machining operation on a workpiece, the machining apparatus including an implement that performs the machining operation and one or more motors coupled to the implement which are controllable to change a position of the implement relative to the workpiece; and
a controller comprising a motion controller, a control application, and an operator panel having a set of jogging controls respectively corresponding to forward or reverse directions of the one or more motors,
wherein the set of jogging controls are respectively configured to output variable signals corresponding to respective degrees of engagement by an operator, the variable signals from the set of jogging controls are processed by the control application to generate jogging output signals which are proportional thereto, the motion controller generates motor drive signals based on the jogging output signals, the motor drive signals driving the one or more motors in the forward or reverse directions at a speed proportional to the degrees of engagement of the set of jogging controls.
